(19) United States
(12) Patent Application Publication
(10) Pub. No.: US 2018/0307912 A1
(43) Pub. Date: Oct. 25, 2018

(54) UNITED STATES UTILITY PATENT APPLICATION SYSTEM AND METHOD FOR MONITORING VIRTUAL PERIMETER BREACHES

(71) Applicants: DAVID LEE SELINGER, PLEASANTON, CA (US); CHAOYING CHEN, TAIWAN (CH)

(72) Inventors: DAVID LEE SELINGER, PLEASANTON, CA (US); CHAOYING CHEN, TAIWAN (CH)

(21) Appl. No.: 15/492,010

(22) Filed: Apr. 20, 2017

(51) Int. Cl. G06K 9/00; G06K 9/78; G06K 9/62; G06N 3/08; G06N 3/04

(52) U.S. Cl. CPC G06K 9/00771; G06K 9/00718; G06N 3/04; G06K 9/6256; G06N 3/08; G06K 9/78

(57) ABSTRACT

A video security system and method for monitoring active environments that detects a security-relevant breach of a virtual perimeter and can track a virtual perimeter breaching object to detect risk-relevant behavior of persons and objects such as loitering and parking, and provides fast and accurate alerts. The system is able to achieve advance alerts by monitoring an extended virtual perimeter. The image processing module of the system employs a deep learning neural network (DNN) for fast image processing. The system can further increase speed by reducing the image data that is being processed to data extracted from one or more reduced data sources including virtual perimeter zones, a delta of a series of image frames, and a representative image frame of a series of frames.

### FIELD OF THE INVENTION

The present invention generally relates to surveillance systems for areas monitored to provide security, in particular areas having an active environment such as the interiors and exteriors of residential homes.

### BACKGROUND OF THE INVENTION

Presently available security surveillance systems are useful for identifying suspects after a burglary and may have a deterrent effect, but too often fail to effectively prevent a crime from happening. An important characteristic that is still lacking from current systems is the reliable detection of all security-relevant events combined with a low rate of false-positives, to ideally trigger an alert before an actual physical breach of a protected area such as a residential home occurs. For example, facial recognition-focused methods require a constrained field of view, lack the potential to protect an entire yard or compound and thus often cannot provide sufficient advance warning.

Systems focused on motion detection lack the accuracy to differentiate between a potential security concern (human, car), and objects not usually relevant for security (animals, trees or other inanimate objects moving in the wind). Hundreds if not thousands of motion events happen in the perimeter of a normal-sized home every day. These are far too many to be useful to be tracked and monitored. For the majority of homes, the false-positive rate (a statistical measure of inaccuracy) is far in excess of 99%, making motion-based systems impractical.

Available systems may be able to detect objects such as people and cars but are similarly hampered by an excessive false-positive rate in active environments, where such objects regularly and legitimately occur. Available systems for active environments focus on detecting anomalies which may lower the false-positive rate, but require frequent human intervention to review all detected anomalies, and increases the risk to miss a security-relevant event.

Therefore, there is a need in the art for a system and method that provides fast and accurate security alerts and can achieve a low rate of false positives without the need for frequent human intervention. These and other features and advantages of the present invention will be explained and will become apparent to one of ordinary skill in the art in the following.

### SUMMARY OF THE INVENTION

Accordingly, embodiments of the present invention are directed to systems and methods for security monitoring that employ one or more imaging devices operably linked to a computing device which is operably linked to an alert device, and configured for detection of entry of relevant objects into a virtual perimeter. The computing device is configured to detect a breach in a virtual perimeter once entered, and to trigger the alert device if it determines that the detected breach is relevant to security or additionally or alternatively, poses a pre-determined risk as determined by the system.

In preferred embodiments of the present invention, a virtual perimeter of the system and method ideally extends well beyond the target area to be secured in order to optimize advance warning. Embodiments of the invention can increase system speed, and thus breach detection and alert triggering, in various ways. In one group of preferred systems and methods, the image processing speed is increased by reducing the amount of image data that is being further processed, e.g. in one or more component of the image processing module, to data extracted from one or more reduced data sources including virtual perimeter zones, a delta determined from a series of image frames, and a selected representative image frames from a series of image frames.

According to an embodiment of the present invention, a system for security monitoring comprises one or more imaging device operably linked to a computing device, wherein: the imaging device is configured to provide image data to an image processing module of the computing device; the computing device is configured to receive the image data and to process the image data in its image processing module; said image processing module comprises a deep neural network (DNN), and comprises an object detection component, a breach detection component, and an object classification component, and is configured for entry of one or more virtual perimeter zone; said object detection component is configured to detect one or more objects in the image data; said breach detection component is configured to detect one or more breaching object within the virtual perimeter zone; said object classification is configured to determine one or more classes for the detected object; and wherein the computing device is operably linked to one or more alert device, and is configured to trigger the alert device if a breaching object is of one or more security-relevant class.

According to an embodiment of the system of the present invention, the image processing module of the system additionally comprises an object tracking component and a behavior detection component, the object tracking component is configured to track one or more virtual perimeter breaching mobile object, and the behavior detection component is configured to detect one or more behavior of the tracked object to allow the image processing module to identify risk-relevant behavior, said risk-relevant behavior comprising stopping or prolonged presence of a mobile object, vehicle or person in one or more virtual perimeter zone; and the computing device is operably linked to one or more alert device, and is configured to trigger the alert device if risk-relevant behavior is identified by a component of the image processing module.

According to an embodiment of the system of the present invention, the computing device is configured to reduce the amount of image data processed in one or more component of its image processing module to image data extracted from one or more reduced data source comprising one or more virtual perimeter zone, a delta determined from a series of image frames, and a selected representative image frame from a series of image frames.

According to an embodiment of the system of the present invention, the computing device is configured to extract data from one or more virtual image zone, and said extracted delta is selected for further image data processing by one or more of the components of the image processing module.

According to an embodiment of the system of the present invention, the computing device is configured to extract a delta between two or more individual frames of a series of image frames, and said extracted delta is selected for further image data processing by one or more of the components of the image processing module.

According to an embodiment of the present invention, the computing device is configured to select one or more most representative image frame of one of the objects detected in a series of multiple image frames of larger quantity than the one or more most representative frames, and communicates only the one or more most representative image frame to one of the components of the image processing module, including one or more of the object detection component, object tracking component, breach detection component, behavior detection component, and object classification component.

According to an embodiment of the system of the present invention, the one or more virtual perimeter zone extends beyond one or more outer boundary of a corresponding to be protected physical perimeter zone by a distance of 2 foot or more.

According to an embodiment of the system of the present invention, the computing device is configured to compress the image data before receiving it in the image processing module, and to compress data related to image data processing comprising DNN coefficients and DNN model update data in the image processing module.

According to an embodiment of the system of the present invention, the computing device is configured to compress data comprising image data and data related to image processing before receiving it by transmission to the image processing module, and to uncompress said data after transmission.

According to an embodiment of the system of the present invention, the computing device is configured to compress image data and DNN coefficients data before transmission to the image processing module, and to process it in one or more image processing module component in compressed form.

According to an embodiment of the system of the present invention, the image processing module is configured to receive data that comprises DNN coefficient data but not image data, to create an updated DNN model in one of its components, and to transmit it in compressed form to one or more image processing module components.

According to an embodiment of the system of the present invention, the alert is transmitted to a user and the user is required to confirm before final transmission, the final transmission including one or more of sounding of a sound-emitting device or siren, and transmission to one or more of security personnel, guard service, and law-enforcement.

According to an embodiment of the present invention, a method for security monitoring comprises the steps of: providing image data from one or more imaging device to one or more computing device, wherein said computing device comprises an image processing module which is configured with one or more virtual perimeter zone; receiving said image data in an image processing module of the computing device; and further processing the image data in an object detection component, a breach detection component, and an object classification component of the image processing module; wherein said further processing comprises the steps of: detecting one or more objects in said object detection component, detecting a virtual perimeter breaching object in the breach detection component, and determining one or more classes for each object in said object classification component; and determining if the virtual perimeter breaching object is of one or more security-relevant class thus detecting a security-relevant breach; and upon detecting a security-relevant breach, triggering an alert device operably connected to the one or more computing device.

According to an embodiment of the present invention, the method for security monitoring may additionally comprise the steps of further processing the image data in an object tracking component and a behavior detection component of the image processing module, and said further processing may comprises the additional steps of: tracking one or more virtual perimeter breaching object in said object tracking component, detecting a behavior of the tracked object in the behavior detection component, determining if the behavior is of one or more risk class thus identifying a risk-relevant behavior, and upon identifying one or more risk-relevant behavior, triggering an alert device operably connected to the one or more computing device.

According to an embodiment of the present invention, the method may additionally comprise the step of extracting image data by selecting one or more reduced data source to provide the image data that is further processed in one or more of the object detection component, breach detection component, and object classification component of the image processing module,

According to an embodiment of the method of the present invention, the reduced data source is selected from the group consisting of: a virtual perimeter zone, a delta determined from a series of image frames, and a representative image frame selected from a series of image frames.

According to an embodiment of the method of the present invention, one or more of the computing device, image processing module, object detection component, breach detection component, and object characterization component receives only the extracted image data.

According to an embodiment of the method of the present invention, the computing device comprises multiple devices or units thereof configured in a network, and all off-site units of said network receive only the extracted image data.

According to an embodiment of the method of the present invention, the reduced data source is a virtual perimeter zone.

According to an embodiment of the method of the present invention, the reduced data source is a delta determined from a series of image frames.

According to an embodiment of the method of the present invention, the reduced data source is a representative image frame, and the step of extracting data comprises determining a most representative image frame for one of the objects detected in a series of multiple image frames, and providing only the data corresponding to said most representative image frame to one or more of the breach detection component, and the object classification component.

According to an embodiment of the method of the present invention, the one or more virtual perimeter zone extends beyond one or more outer boundary of a corresponding to be protected physical perimeter zone by a distance of 2 foot or more.

According to an embodiment of the method of the present invention, the data is received in the image processing module by a data transmission, additionally comprising the step of compressing image data, and data related to image data processing comprising DNN coefficients and DNN model update data, before transmission to the image processing module.

According to an embodiment of the method of the present invention, the image and data related to image processing is compressed before transmission, and uncompressed after transmission.

According to an embodiment of the method of the present invention, the image data and DNN coefficients data is compressed before transmission to the image processing module, and processed in one or more image processing module component in compressed form.

According to an embodiment of the method of the present invention, the data received in the imaging module comprises DNN coefficient data but not image data, an updated DNN model is created in an image processing module component, and transmitted in compressed form to one or more of the other image processing module components.

According to an embodiment of the method of the present invention, the alert is transmitted to a user and the user is required to confirm before final transmission, the final transmission including one or more of sounding of a sound-emitting device or siren, and transmission to one or more of security personnel, guard service, and law-enforcement.

The foregoing summary of the present invention and its preferred embodiments should not be construed to limit the scope of the invention. As will be apparent to one of ordinary skill in the art, the embodiments of the invention thus described may be further modified without departing from the spirit and scope of the invention.

### BRIEF DESCRIPTION OF THE DRAWINGS

FIG. 1 illustrates a schematic overview of a security system, in accordance with embodiments of the present invention.

FIG. 2 is a process flow of an exemplary method for security monitoring by determining a security-relevant breach of a virtual perimeter zone in image data, in accordance with embodiments of the present invention.

FIG. 3 illustrates a schematic overview of a computing device, in accordance with embodiments of the present invention

FIG. 4 illustrates a schematic overview of a computer network, in accordance with embodiments of the present invention.

### DETAILED DESCRIPTION OF THE INVENTION

The present invention generally relates to security surveillance systems and methods for detecting security-relevant objects that breach virtual perimeter zones that the computing device is configured to have entered. The system is particularly suited for active environments where objects (people, cars) occur that may or may not be relevant for security, for example in residential areas. The embodiments of the invention employ an image processing module that implements the deep learning architecture of a deep neural network (DNN). The image processing module is configured for efficient image data processing to achieve a high accuracy in detecting security-relevant events without compromising speed. When the virtual perimeter zones are extended properly, the embodiments of the invention allow to accurately detect security-relevant objects that breach a virtual perimeter zone, even before a physical breach of the corresponding target to be secured occurs. Furthermore, mobile objects such as persons or cars may be tracked and behavior such as a prolonged presence in a virtual perimeter zone (e.g. parking or loitering) may be determined and if a relevant risk is identified may trigger an alert depending on a particular risk or classes of risks, rather than at any mere breach of a particular virtual perimeter zone.

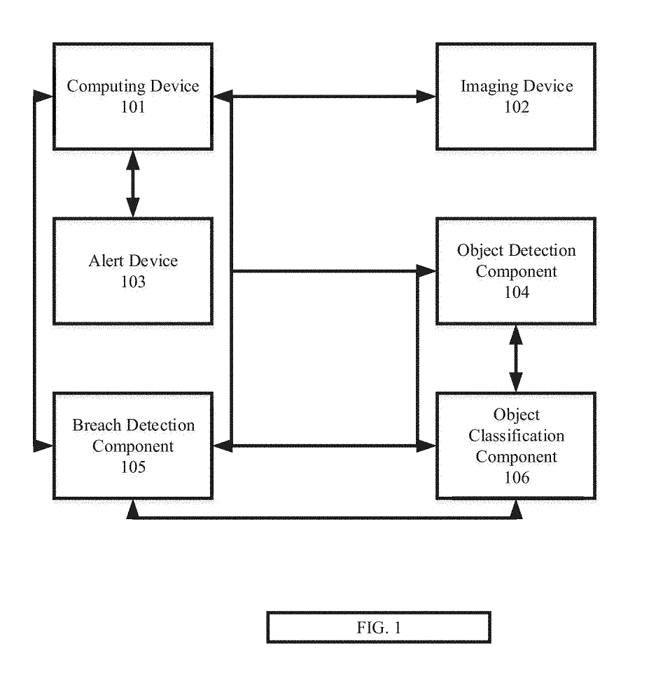

According to an embodiment of the present invention, the system and method is accomplished through the use of a security system as illustrated in FIG. 1. As shown in FIG. 1, in an embodiment of the invention, the system comprises one or more imaging device 102 operably linked to one or more computing device 101 which in turn is operably linked to one or more alert device 103. The one or more computing device separately or in concert is configured to provide an imaging processing module comprised of an object detection component 104, a breach detection component 105, and an object classification component 106.

In one embodiment, the imaging device and the computing device are present in separate housings. Alternatively, both may be present in the same housing (e.g. smart camera). A computing device separate from the imaging device may be on-site in the same or in a physically close location to the imaging device, typically on or adjacent to the property under surveillance. Alternatively, some or all computing devices may be remote devices that are located off-site, in a different physical location. The imaging device may be comprised of multiple sensors or cameras placed in or around a target area to be protected.

Processing of image data by the image processing module of embodiments of the invention may comprise one or more of object detection, object tracking, breach detection, behavior detection/identification, object classification, or any combination thereof. Such processing of the various detection and classification means may occur in corresponding components of the module. One of ordinary skill in the art would appreciate that there are numerous types of detection, identification and classification means that could be utilized with embodiments of the present invention, and embodiments of the present invention are contemplated for use with appropriate detection, identification and classification means.

Optionally, in particular embodiments of the invention, the image processing speed can be increased by reducing the amount of image data that is initially processed or further processed (e.g. directly after image data is captured or transmitted by the imaging device, or after processing in one or more component of the image processing module), in a variety of ways, including the approaches discussed herein-below. Generally, in each of the below approaches, image data is reduced by selecting a reduced image data source and further processing only said reduced image data, rather than the initial image data provided e.g. by the imaging device or a component of the computing device or its image processing module. The reduced data sources that image data can be extracted from include virtual perimeter zones, a delta determined from a series of image frames, and a most representative frame selected from a series of image frames.

In a “perimeter extraction” approach, the computing device may be configured to select one or more virtual perimeter zone as a data source for image data reduction, and extract the image data corresponding to the selected zones, e.g. the outer virtual perimeter, or one or more virtual perimeter zone.

In a “delta extraction” approach, the computing device may be configured to select the image data corresponding to the delta of a series of individual frames (“delta data”). The extraction of delta data may occur before, after or in parallel to perimeter extraction.

In certain embodiments utilizing one or more of the extraction approaches described herein-above, only the resulting extracted data is processed further, e.g. by one or more of the image processing modules. The extraction may occur before any image processing (directly after capture and/or transmission of raw data, formatted, reformatted or initially processed data, from the imaging device or a formatting or initial processing component of the camera or computer system), or just before processing by one or more of the image processing module components.

Such initial image processing may occur by any component of the computing device configured accordingly, including by a component of a smart camera, computing device/network or one or more of its image processing module. The term “initial image processing” is meant to include any image processing that does not involve the object detection, breach detection or object classification components or their dedicated functions. In particular, apart from formatting, initial image processing may optionally involve various global adjustments to an individual image, series of frames, or particular location in a series of frames, such as overall or area-specific exposure, contrast or similar adjustments that are not specific to detecting an object, detecting breach of a perimeter zone by an object, or determining the class of an object.

In a “most representative frame extraction” approach, once the object detection module detects an object (or alternatively after the object classification component determines a class), one or more most representative frame of the detected/classified object is determined, for example by matching and comparing to a database. Only the determined most representative frame (or group of frames) is further processed by the image processing module (in particular by one or more of breach detection and object classification component), thus reducing the number of frames and corresponding data that is further processed. For example, for each series of frames analyzed, a group of 2, 3, 4, or 5 frames may be selected by the system (e.g. by the DNN) for further processing. This approach increases the accuracy of the system, in particular for detecting objects that are difficult to accurately detect, for example due to their size (e.g. insects) or that are difficult to accurately detect in certain conditions, such as movement, lack of light, or a combination thereof (e.g. cars driving through a virtual perimeter zone at night).The database may be programmed into and updated by the computing network, and optionally may be part of and/or updated by one or more of its image processing modules.

Components, functions and configurations of the image processing module of the present invention are shortly summarized hereafter, and their specific configurations in various embodiments of the invention are explained in more detail below.

The object detection component locates potential object regions in an image or multiple image frames, e.g. by motion and form, and passes them to the breach detection and/or object classification component. The component can be implemented by an algorithm, set of algorithms or a DNN (as described herein-below for the object classification component), or combinations thereof. A suitable algorithm that may be included, to give an illustrative example, is a Targeted contrast enhancement (TCE) algorithm. The object detection component optionally selects a representative frame for an object it processes, and reduces processed and/or transmitted image data to only that data that corresponds to the representative frame. Optionally, the selection of a representative frame is achieved in a two-way or three-way communication with the object classification component and the breach detection component, or by an additional dedicated component of the image processing module.

The breach detection component operates based on the entry/definition of one or more virtual perimeter zone (including e.g. an outer perimeter, and/or one or more perimeter zone). Virtual perimeter definitions can be entered manually by a user via a suitable GUI, or programmed to be automatically determined by the security system. The breach detection component may be implemented as an algorithm, set of algorithms or a DNN (for example as discussed herein-below for the object classification component). Based on the virtual perimeter definitions entered, the breach detection component communicates a perimeter breach to one or more image processing module components. In some embodiments, the image data transmitted by breach detection component and/or other components of the image processing module may be reduced to only the image data that is corresponding to the one or more perimeter zone, and thus is less than the total image data for each processed frame.

The object tracking component tracks one or more virtual perimeter breaching object through a series of image frames in time, typically consecutive frames (though frames may be skipped to reduce data, e.g. every other frame may be processed). The object tracking component may be implemented as an algorithm, set of algorithms or a DNN (for example as discussed herein-below for the object classification component), taking into account speed and direction/vectors of movement. The object tracking component is configured to communicate (send, receive and exchange data) with the other components of the image processing module, in particular with the object detection component, breach detection component, and the behavior detection component.

The behavior detection component is configured to detect the behavior of a tracked object and if identified as risk-relevant by a component of the image processing module, to trigger an alert. The behavior detection component may be implemented as an algorithm, set of algorithms or a DNN (for example as discussed herein-below for the object classification component). The behavior detection component is configured to communicate (send, receive and exchange data) with the other components of the image processing module, in particular with the object tracking component, and to either identify detected behavior as risk-relevant, or to communicate data relating to detected behavior to a dedicated risk-identification component of the image processing module. Risk-identification of behaviors may be implemented as an algorithm, set of algorithms or a DNN (for example as discussed herein-below for the object classification component). Such algorithms may in addition identify and classify whether an object holds a certain pose and for how long, the time that an object remains in a certain location, and the speed and direction/vector of movement, and similar. Upon identifying behavior as risk-relevant (e.g. by assigning certain risk classes), the image processing module triggers an alert device operably connected to the computer system.

The object classification component comprises one or more deep learning algorithms or set of algorithms forming a deep learning architecture or Deep Neural Network (DNN). Typically, a DNN has multiple hidden layers of units between input and output layers and can model complex non-linear relationships. In the field of machine learning, deep learning is also known as deep structured learning, hierarchical learning, or deep machine learning. The object classification component performs a classification of the objects detected by a component of the image processing module, in particular the object detection component. Optionally, the classification is restricted to only those detected objects determined to have breached a virtual perimeter zone.

Classes can include groups and one or more subgroups, typically hierarchical with overlap between some subgroups and/or groups. For example, object (sub) group labels can include humans, vehicles (cars, trucks, motorcycles), botanicals (trees, plants, grass, lawn, flowers), inanimate (road, wall, fence, building). The object classification component in communication with the object detection component and breach detection component generates DNN coefficients and DNN model update data that is again transmitted to the object detection, and breach detection component, and any optional component of the image processing module dedicated to the purpose. The object classification component optionally selects a representative frame for an object it processes, and reduces processed and/or transmitted image data to only that data that corresponds to the representative frame. Optionally, the selection of a representative frame is achieved in a two-way or three-way communication with the object detection component and the breach detection component, or by an additional dedicated component of the image processing module.

According to an embodiment of the present invention, a computing device is configured to trigger the one or more alert devices it is operably linked to, upon virtual perimeter breaches that it determines to be security-relevant in communication with its one or more image processing modules (which detect and classify objects and determine a breach of a perimeter zone by a detected and/or classified object). Different rules or algorithms may apply to certain groups of objects, and may be assigned e.g. by the object classification component, or by a separate operably linked component that is programmed to apply these group rules or algorithms to certain classified objects, based on their class.

The group rules/algorithms can be pre-programmed, or can be learned and provided by the image processing module. For example, group rules could apply to groups such as known threats, strangers/potential threats, known harmless objects, family & friends, particular individuals, particular animals (own pet, neighbor's vicious dog), particular vehicles/known threats, particular vehicles/family & friends or similar. The triggered alert may be one or more type of alert depending on which objects, class, group of objects or group of classes (in case of group rules) breached, and/or where the breach occurred (e.g. particular perimeter zone, or specific part thereof).

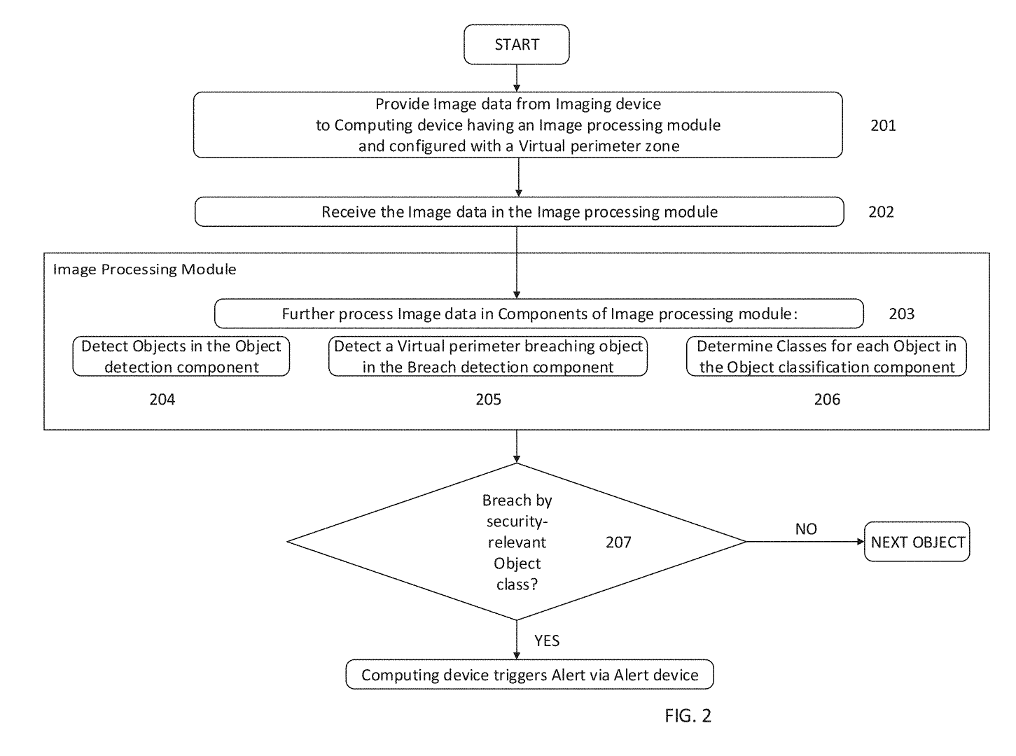

Turning now to FIG. 2, an exemplary method for security monitoring by processing of image data by object detection and classification, and determination of a breach of a virtual perimeter zone by a security-relevant object. As shown in FIG. 2, Image data is provided by an imaging device such as a video camera to a computing device. The image data is received by the computing device that is configured with a virtual perimeter zone, and further processed in its image processing module, by detecting any objects in its object detection component, detecting any virtual perimeter breaching object in the breach detection component, and determining classes for each object in the object classification module. If the computing device in communication with its image processing module determines that there is a virtual perimeter breaching object that is of one or more security-relevant class, then the computing device triggers an alert through the alert device it is operably linked to. In preferred embodiments, imaging data can be reduced, and thus processing speed increased, by selecting a reduced data source, for example, only the areas of processed image frames that correspond to the virtual perimeter zone are further processed. In other preferred embodiments, the source of reduced data may be the delta between frames (e.g. corresponding to moving objects, thus frames showing the normal surroundings without any active object will not be further processed). In other preferred embodiments, the source of reduced data may be selected representative frames, where only frames with detected objects are selected, (or only frames with a particular class of objects), and from those frames only a subset of representative ones is selected for further processing.

In addition, the movement and duration of presence of a detected object that breaches a virtual perimeter zone may be tracked in time and direction by the object tracking component, and the behavior detection component may detect the tracked object's behavior. Detected behaviors of tracked objects may include, for example, stopping in a virtual perimeter zone, in particular if the zone is risk-sensitive (door, window, mailbox), and prolonged presence in a virtual perimeter zone, in particular in risk-sensitive ones, for example at particular times, or in case of a person, remaining in a particular pose or exhibiting particular activities (crouching, carrying tools, manipulating sensitive objects). For example, in case of people or vehicles, the detected behaviors may relate to loitering, parking or potential preparations to enter a virtual perimeter zone. The image processing module may detect and identify the above (e.g. by algorithms that classify behaviors) taking into account repeated or prolonged occurrences thereof, and risks may be assigned to behaviors or classes thereof, e.g. based on particular times (hours of the day, days of the week, seasonal) and/or particular risk-sensitive virtual perimeter zones (e.g. parking during hours when the house is unoccupied, or loitering of a person at a door or window during night time), and in case of persons, particular poses that indicate risk (e.g. nervous pose or facial expression, actions that indicate preparations to enter a sensitive zone etc.). Detected/identified behaviors that relate to preparations to enter may include, for example, crouching beneath a window, approaching a sensitive zone, manipulating or opening a window, a door or a mailbox. Identifying a risk-relevant behavior for a tracked object will trigger an alert device.

Embodiments of the invention may optionally use data compression approaches to further increase system speed, and particularly transmission speeds therein. Capturing, transmitting and processing imaging camera data, especially through a DNN, typically creates a large amount of data that can reduce speed. For the computing device or network of embodiments of the present invention to be able to handle the amount of data in even less time, the following optional approaches for data compression may be used in addition or instead of approaches to reduce image data as described-herein. The below data compression approaches are useful for the communication between security system, imaging device and alert device, between computing devices each comprising one or more components of an imaging module, or between components of the image processing module(s), that may be part of one or more computing device or network.

Optional approaches for data compression include:

Compression of all image processing-related data before transmission: Image, DNN coefficients and DNN model update data is compressed before transmission, and uncompressed after transmission, e.g. by the DNN of the image processing module, in particular the object classification component.

Compression of image and DNN coefficients data and processing in compressed form: Image and DNN coefficients data is compressed before transmission, and upon transmission, processed by the DNN of an image processing module component, in particular the object classification component, in compressed form. The DNN of an image processing module, in particular the object classification component, then generates an updated model and sends it in compressed or uncompressed form to one or more other image processing module components.

Compression of only DNN coefficient data and the updated DNN model: Only DNN coefficient data (but not image data) is transmitted to the DNN of an image processing module, in particular the object classification component, while the image data stays on site with the imaging device(s) (and optionally on site with any on site computing device linked to the imaging device). The DNN of the image processing module, in particular the object characterization component, compresses the updated DNN model, then transmits the compressed model back to one or more of the other image processing modules. The compressing then re-transmitting DNN may be localized off site, or may be on site but not physically linked to the other components of the image processing modules and/or computing device(s).

The above compression approaches are described in more detail in patent applications XY, filed in parallel on February XY, 2017, and whose content relevant to data compression or selective data transmission is incorporated herein by reference in its entirety. Where a definition or use of a term in a reference, which is incorporated by reference herein is inconsistent or contrary to the definition of that term provided herein, the definition of that term provided herein applies exclusively.

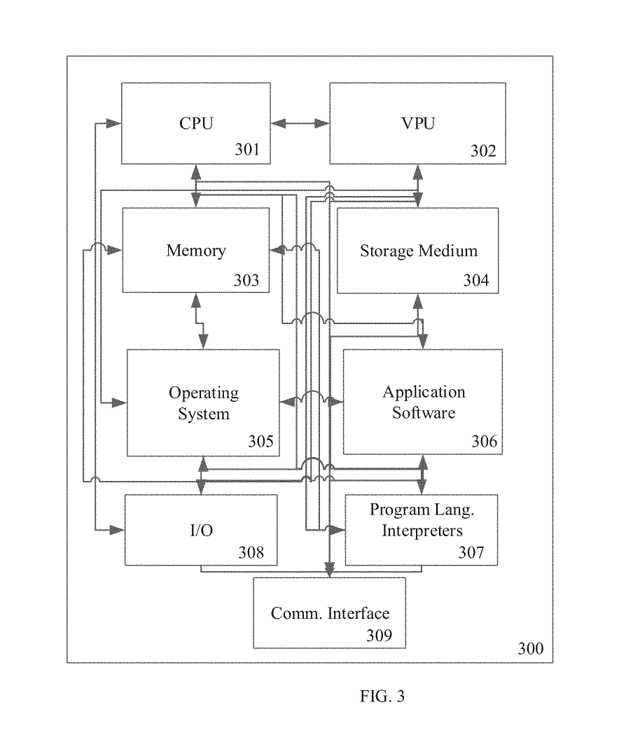

An illustrative representation of a computing device appropriate for use with embodiments of the present invention is shown in FIG. 3. The computing device can generally be comprised of a Central processing Unit (CPU, 301) with one or more vision processing unit (VPU, 302), or alternatively a functionally equivalent image processing “accelerator” (e.g. video processing unit, integrated or dedicated graphics processing unit (GPU) or similar, optimized for image processing speed), a non-transitory memory (e.g., Random Access Memory) (Memory, 303), a storage medium 304 (e.g., hard disk drive, solid state drive, flash memory, cloud storage), an operating system (OS, 305), one or more application software 306, one or more programming language interpreters 307, and one or more input/output devices/means 308 including one or more communication interfaces (e.g., RS232, Ethernet, Wifi, Bluetooth, USB) 309. Useful examples include, but are not limited to, personal computers, smart cameras/vision sensors, smart phones, laptops, mobile computing devices, tablet PCs, and servers. Multiple computing devices can be operably linked to form a computer network in a manner as to distribute and share one or more resources, such as clustered computing devices and server banks/farms.

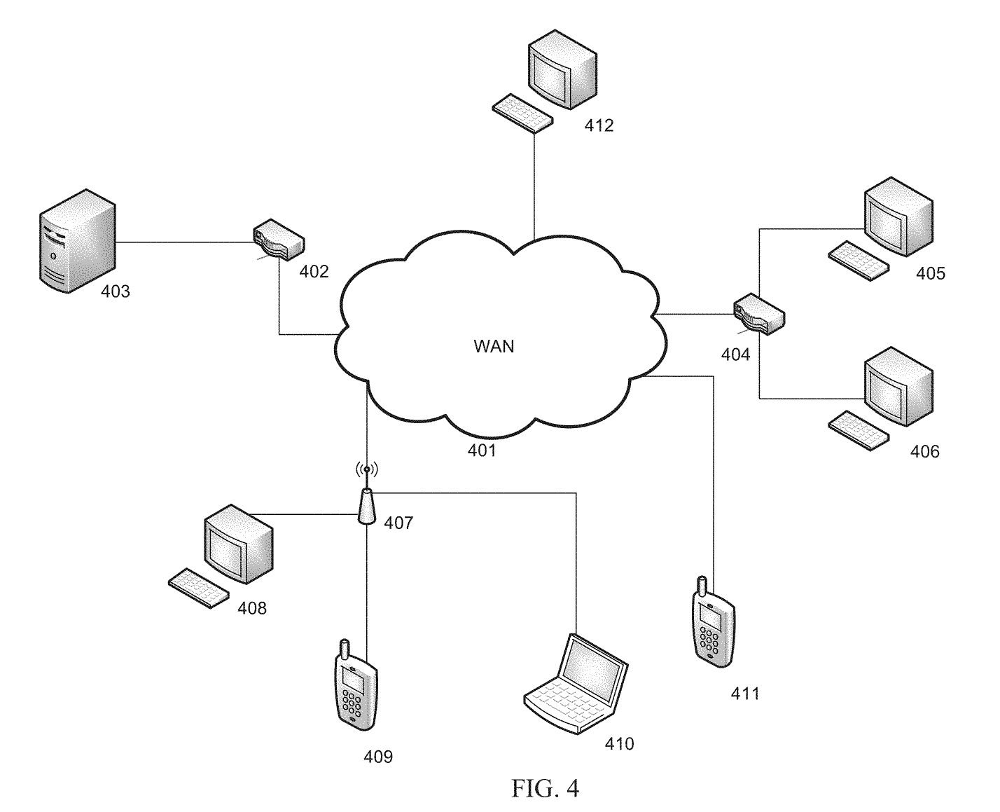

Various examples of such general-purpose multi-unit computer networks suitable for embodiments of the invention, their typical configuration and many standardized communication links are well known to one skilled in the art, as explained in more detail and illustrated by FIG. 4, which is discussed herein-below.

Optionally, to facilitate processing and communicating image and image-related data, suitable networks may run a framework, e.g. Open Computing Language (OpenCL), for writing programs that execute across heterogeneous platforms such as CPUs, VPUs, GPUs, Digital signal processors (DSPs), and Field Programmable Gate Array (FPGAs). A computing network typically consists of several computing units, which in turn comprise multiple processing elements (PEs). A single kernel (function) execution can run on all or many of the PEs in parallel. A computer network can be subdivided into computing units and PEs in many different ways to allow for efficient image data processing.

VPUs useful in embodiments of the present invention can be selected from one or more of Microsoft hololens (aimed at interpreting camera inputs to accelerate environment tracking and vision with a “Holographic Processing Unit” accelerator that is complimentary to its CPU and GPU), Eyeriss by MIT (runs CNNs), NeuFlow by Yann LeCun (implemented in a FPGA, runs a pre-trained CNN and accelerates convolutions using a dataflow architecture) Movidius Myriad 2, and NEOVUS (Neuromorphic Visual Understanding of Scenes, a neuromorphic architecture for real-time automated video object recognition inspired by the what/where streams of the mammalian visual cortex that integrates retinal processing, object detection based on form and motion modeling, and object classification based on CNNs).

Instead of or in addition to a VPU, one or more accelerators, AI accelerators or GPUs may be used in embodiments of the present invention as functional equivalents of a VPU either individually or as multiple units acting in concert, if configured to achieve the necessary speed and processing power in embodiments of the present computing device, in particular, for example, a network of computing devices (or operably linked components thereof), as will be apparent to one of ordinary skill in the art.

AI accelerators that may function as a VPU include, for example, IBM TrueNorth (neuromorphic processor aimed at sensor data pattern recognition and intelligence tasks including video), and Qualcomm Zeroth Neural processing unit (a sensor/AI oriented chip). Other useful processors with VPU functionality include Adapteva Epiphany (a manycore processor with similar emphasis on on-chip dataflow, focused on 32 bit floating point performance), CELL (a multicore processor with features consistent with vision processing units, incl. SIMD instructions & datatypes suitable for video, and on-chip DMA between scratchpad memories), Digital signal processors (designed to work with real-time data streams), OpenCL framework for parallel computing, Multiprocessor system-on-chip (MPSoC), Coprocessors to supplement the CPU in graphics and related operations, Physics processing unit (complements CPU and GPU with a high throughput accelerator).

Graphics processing units (GPU) that have the ability to run vision algorithms are also useful in embodiments of the present invention; for example, NVidia's Tegra architecture (to provide a tradeoff of low-power consumption and low-cost processing in a compact, high-performance chip), and NVidia's Pascal architecture which includes FP16 support (to provide a better precision/cost tradeoff for AI workloads).

Imaging devices useful in embodiments of the present invention include any camera (digital or analog), image sensor (matrix or linear, CCD or CMOS), video camera or smart camera (also known as a vision sensor), that transmits output data in a format compatible with an input channel into the computing device/network of the present invention, or that transmits output data that can be transformed into such a compatible format. The imaging device can house the computing device or part of the computing network (smart camera) to perform local/on site data processing. Alternatively, the imaging device can be operably linked to a separate computing device/network for remote data processing via communication link, or part of the modules or components of the computing device can be housed in the camera and another part of its components can be remotely linked, for partial remote data processing. The computing device or network thus can be localized off site from the camera and receive data via a communication link. The data can be processed by one or more computing devices part of a computing network, each individual computing device sharing resources and/or contributing to data processing. The camera can be a dome camera, IP camera, or CCTV camera (if wired to connect to the computing network), and its lens can be standard or fisheye, it can be mounted in a particular position or move/swivel to cover a larger area. Useful imaging devices include, for example, cameras manufactured by Dahua, Hikvision and QSee, such as a real-time encoded h264 stream camera, bullet style IP security cameras Hikvision DS-2CD2032-I or Dahua IPC-HFW4300S, and many more options that will be apparent to one of ordinary skill in the art.

In embodiments of the invention, the computing device and the image processing module can connect to the imaging device using one or more standard protocol to establish and control imaging device sessions and/or transmit image data, optionally in compressed form, for example, Real Time Streaming Protocol (RTSP), Hypertext Transfer Protocol (HTTP), intraframe-only compressed Motion JPEG (MJPEG), and interframe compressed MPEG1, MPEG2, MPEG-4, MPEG-4 part 2 and H.264 (also known as MPEG-4 part 10 AVC, or as H.264/MPEG-4 AVC).

The computing device or network in embodiments of the present invention is configured to provide an image processing module that comprises among its other functional units as described herein-above an object classification component.

The object classification component appropriate for use with embodiments of the invention is typically configured in form of a deep learning architecture or DNN. Object detection and breach detection components of the image processing module of the present invention may be similarly configured as described for the object classification component herein-below. Alternatively, in some embodiments, their DNN configuration may differ, or they may be configured using a different algorithm or set of algorithms. For example, algorithms used for object detection typically tend to be simpler and do not require a DNN or other similarly complex computing architecture.

The object classification component, object tracking component, and behavior detection/identification component appropriate for use with embodiments of the invention comprises one or more deep learning algorithms or set of algorithms forming a deep learning architecture or Deep Neural Network (DNN) that has multiple layers between input and output layers and can model complex non-linear relationships and high level abstractions. Deep learning is also known as deep structured learning, hierarchical learning, or deep machine learning. Alternatively, if the requirements of speed and the functionalities of the image processing module component of interest described herein-above are met, any machine learning/artificial intelligence computing architecture may be used for the respective component, as will be apparent to one of ordinary skill in the art.

DNN architectures for object classification (and similarly object-based tracking or detection/identification of object behavior) generally generate compositional models where the object is expressed as a layered composition of image primitives. The extra layers enable composition of features from lower layers, giving the potential of modeling complex data with a limited number of units. DNNs are typically designed as feedforward networks, but recurrent neural networks (RNNs), especially LSTM may also be useful. Convolutional deep neural networks (CNNs) are particularly useful in many embodiments of the invention.

The main objective of object tracking is to associate target objects in consecutive video/image frames, and determine e.g. direction and speed of movement (or lack thereof) while taking into account that the tracked object may change orientation and appearance over time. Various methods and algorithms are available and will be apparent to a person of ordinary skill in the art. A few illustrative and non-limiting examples follow. The object tracking component may employ one or more motion models and related algorithms, including, for example, 2D transformation for planar objects, disruption and division of key frames into macroblocks and translation into motion vectors given by the motion parameters, tracking of deformable objects by covering them with a mesh and defining motion by position of nodes of the mesh, target representation and localization tracking processes such as contour tracking (detection of object boundaries by e.g. active contours or a condensation algorithm) and kernel-based tracking (iterative localization based on maximization of a similarity measure/Bhattacharyya coefficient), as well as filtering and data association filters such as a Kalman filter (optimal recursive Bayesian filter for linear functions subjected to Gaussian noise) or a particle filter (useful for sampling the underlying state-space distribution of nonlinear and non-Gaussian processes).

To implement the one or more DNN in a computing device or network of an embodiment of the invention, Commercial-off-the-shelf (COTS) hardware can be used. For example, a field programmable gate arrays (FPGAs) implemented with a VPU or functional VPU-equivalent as discussed herein-above.

DNN architectures useful in embodiments of the invention can, for example, include one or more of a particular DNN such as a CNN's and RNN's. Each such CNN, RNN etc. can be implemented in many different configurations (e.g. number of layers in a CNN, number of nodes in a RNN, etc), as will be apparent to one of ordinary skill in the art. In embodiments of the invention, one particular architecture or multiple architectures may be used, and each architecture used may have its particular specific or multiple configurations.

In embodiments of the present invention wherein components of the image processing module(s), imaging device(s), computing device(s) or networks are distributed over one or more off-site and one or more on-site location, each of these on-site or off-site units (image processing module, their module components, imaging devices, computing devices computing networks and their device or network components) can transmit and share all or some of their data between one or more locations.

In some embodiments of the present invention, the data shared between on-site and off-site units can be restricted to the updated DNN coefficients (generally in transmission direction on-site transmitting to off-site or “on-site to off-site”), and/or to the updated DNN model version (generally off-site to on-site). Optionally, rotating updated DNN model versions can be transmitted from one or more off-site units to one or more on-site unit according to a rotation schedule. The rotation schedule can include all off-site units, or a smaller selection thereof, optionally in particular groups of off-site units. These groups and rotation schedules can be pre-determined or learned by the image processing modules of the security system. Each rotation yields new updated DNNs that can be send to one or more on-site locations, generating the next rotation. Any number of rotation is possible, a useful number of rotations include from 10 to 100.000 or more, for example 10, 25, 50, 100, 250, 500, and 1000.

There is a multitude of deep learning architectures or deep neural networks (DNNs) useful for embodiments of the present invention, many of which are branched and modified from an original parent architecture. One of ordinary skill in the art will appreciate that many parent or child architectures can be used and still further modified according to the functional requirements as described herein. Illustrative DNNs include, without limitation, Convolutional Neural Network (CNN), Deep belief network (DBN), Conditional DBN, DBN with sparse feature learning, Convolutional deep belief network (CDBN), Large memory storage and retrieval neural networks (LAMSTAR), Deep Boltzmann Machines (DBM), Stacked (de-noising) auto-encoders, Deep auto encoders, Deep coding networks, also known as Deep predictive coding networks (DPCN), Deep Q-networks (DQN), Deep stacking networks (DSN), Tensor DSN (TDSN), Restricted Boltzmann Machine (RBM)-based spike-and-slab RBM (ssRBM), μ-ssRBM, Recurrent Neural Network (RNN), long short-term memory (LSTM), Neural Stack machines, LSTM “forget gates”, Self-referential RNNS, Neural Turing machines, Memory networks with long-term memory, Pointer Networks, Encoder-decoder networks, and Multilayer kernel machine (MKM).

In certain embodiments of the present invention, one or more of the object classification, object detection, and breach detection component is configured as a Convolutional Neural Network (CNN), or a modification thereof. CNNs typically are supervised DNNs with multiple layers of similarly structured convolutional feature extraction operations followed by a linear neural network (NN) classifier. Modelled from the mammalian visual cortex, CNNs generally have alternating layers of simple and complex cells. Simple cells perform template matching and complex cells pool these results to achieve invariance. A typical CNN has several of 3-layer convolution stages followed by a classifier stage which is a linear NN with one or more hidden layers. Each convolution stage has three layers: a filter bank layer (convolutions) to simulate simple cells, a non-linearity activation layer, and a feature pooling layer to simulate complex cells. The network can be trained, for example, using backpropagation with gradient decent, including stochastic gradient descent, batch gradient descent, and mini-batch gradient decent. Alternatively or additionally, one or more sophisticated algorithm to optimize gradient descent may be used, for example, ADAM (an algorithm for first-order gradient-based optimization of stochastic objective functions, based on adaptive estimates of lower-order moments), its variant AdaMax, Momentum, Nesterov accelerated gradient, Adagrad, Adadelta, or RMSprop. Various gradient descent optimization algorithms are known and may be used to train a CNN, as will be apparent to a person of ordinary skill in the art.

Within the Convolutional Neural Networks or CNNs and their modifications, again a great variety of types and particular species are useful in embodiments of the present invention, as one of ordinary skill in the art will be able to appreciate, and optionally further modify, including by combination (for example in an ensemble model), according to the functional requirements as discussed for embodiments of the invention herein. Such useful types of CNNs generally include, for example, without limitation:
Methods that use unsupervised pre-training to structure a neural network, to make the CNN first learn generally useful feature detectors, followed by supervised back-propagation to classify labeled data;
Pre-trained or partially pre-trained networks, whereby the initial architecture and/or network nodes and/or coefficients will be pre-populated based on training from image sources such as ImageNet or MNIST.
Spatial Transformer Networks designed to mathematically transform every classified image (or set of images) to a learned canonical orientation and scale such image in a way that is differentiable and learned from the training data.
Discriminative training with a backpropagation algorithm that is efficient even when the networks are sparse and that generates useful internal representations of incoming data in hidden layers of neural networks.
Deep learning feedforward networks that alternate convolutional layers and max-pooling layers, topped by several fully connected or sparsely connected layer followed by a final classification layer, wherein training is usually done without any unsupervised pre-training;
Pre-trained Restricted Boltzmann Machine (RBM) that divides objects into two or more groups based on a feature selection algorithm;
Generative feature learning algorithms, for example, a Point-wise Gated Boltzmann machine (PGBM);
Convolutional model where the PGBM is extended to a convolutional setting, with filter weights shared over different locations in an image;
Point-wise gated convolutional deep network (CPGDN) that uses a convolutional extension of the PGBM as a building block;
Max pooling while using convolution (can detect and classify 3-D objects, and achieves shift invariance and tolerance to deformation to enable the network to tolerate small-to-large deformation in a hierarchical way, e.g. used by Cresceptron).

Alternatively or additionally, Compound hierarchical-deep models (Compound HD) that compose deep learning networks with non-parametric Bayesian models and learn features using deep learning architectures such as the ones aforementioned herein (e.g. DNN, CNN, DBN etc.) are also useful in embodiments of the present invention. A few illustrative examples of the compound HD models are a Hierarchical Bayesian (HB) model, and a compound HDP-DBM, also known as a hierarchical Dirichlet process (HDP).

Particular species of CNNs useful in embodiments of the present invention include, for example, without limitation: ResNet (designed by Microsoft Research), Inception (designed by Google), Inception-Resnet (Hybrid models combining the best of Inception and Resnet), Residual models (custom architectures extracting the significant “Residual learning module” from Resent), Inception Models (custom architectures extracting the significant “Inception module” from Inception), AlexNet (the ILSVRC-2012 winner), VGG (the ILSVRC-2014 winner), Neocognitron (a CNN partially trained by unsupervised learning with human-directed features), Cresceptron (3-D object recognition from images of cluttered scenes and detection/segmentation of such objects from images), Schmidhuber's multi-level hierarchy of networks (pre-trained one level at a time by unsupervised learning, fine-tuned by backpropagation, where each level learns a compressed representation of the observations that is fed to the next leve), Hochreiter & Schmidhuber's long short-term memory (LSTM) network, Sven Behnke's Neural Abstraction Pyramid (relies only on the sign of the gradient (Rprop) to solve problems including image reconstruction and face localization), Hinton's deep model of 2006 (involves learning the distribution of a high-level representation using successive layers of binary or real-valued latent variables, uses a RBM to model each new layer of higher level features, and may be used as a generative model by reproducing the data when sampling down the model from top level feature activations), Dan Ciresan's many-layered back-propagation deep feedforward neural networks of 2010, Google Brain's neural network of 2012 (recognizes higher-level concepts such as cats only from watching unlabeled images taken from YouTube videos); and Developmental Networks (DNs) such as Where-What Networks (WWN), WWN-1, WWN-2, WWN-3, WWN-4, WWN-5, WWN-6, and WWN-7 (generally WWN guarantee shift invariance to deal with small and large natural objects in large cluttered scenes, invariance is extended beyond shift to all learned concepts such as location, type/object class label, scale, and lighting).

Software libraries, GUI frameworks and cloud services useful to implement the above architectures in embodiments of the invention are publicly available and designed for a variety of programming languages, as will be apparent to one of ordinary skill in the art. Such software libraries include, for example, Theano, Tensorflow, Deeplearning4j, OpenNN, and Apache Mahout. Illustrative examples of GUI frameworks include Jupyter, Encog, Neural Designer, Neuroph, OpenCog, RapidMiner, and Weka, and a useful cloud service may be Grok.

In embodiments of the invention, learning of a deep learning architecture or a DNN such as the types, their variants and species detailed above can be supervised, semi-supervised, or unsupervised. For supervised or semi-supervised learning, typically labeled datasets are used. For unsupervised learning, the datasets need not be labeled.

In embodiments of the invention, multiple instances of a group of deep learning architectures may be computed either in parallel or in serial, and their results may be combined using a traditional or unique ensemble approach to benefit from the strengths of a plurality of different network architectures.

Datasets may include image and related data generated by the system described herein, or pre-existing datasets may be used instead or in addition, as will be apparent a person of ordinary skill in the art. Illustrative Datasets useful to train a DNN of the image processing module and its components, and in particular the object characterization component of embodiments of the invention, include, for example: IMAGENET, the Caltech 101, Caltech-256, COC (Microsoft Common Objects in Context), Berkeley 3-D Object Dataset, SUN Database, ImageNet, Statlog (Image Segmentation) Dataset (with calculated features), LabelMe, PASCAL VOC, CIFAR-10, CIFAR-100, FERET (Facial Recognition Technology), Pose, Illumination, and Expression (PIIE), SCFace, YouTube Faces DB, Aerial Image Segmentation (AIS), KIT AIS, Overhead Imagery Research Data Set, Stanford Dogs Dataset, UCF 101, THUMOS, Activitynet, Caltech-UCSD Birds-200-2011, YouTube-8M, and Cloud DataSet. Such data sets generally use uniform noise or natural images as background patterns, to distinguish potentially security-relevant objects from security-irrelevant background.

The Alert device appropriate for use with embodiments of the invention includes a variety of devices and methods to alert a user of the security system to a breach determined to be security-relevant by a security system of the present invention. Alert options include on-site or off-site sound, visual or haptic alert devices (siren, horn, loud speaker, flashing lights, vibrator or similar), software notification, email message, phone text message, security service/guard alert, a central monitoring station, 911 call/police alert or similar that optionally are paired with one or more of an on-site or off-site sound, visual or haptic alert. Any device or method that achieves alerting the user can be used, as will be apparent to one of ordinary skill in the art.

The alert may be triggered fully automatically by the system and e.g. shared with security personnel or law-enforcement directly, or alternatively, the initial determination by the system may be automatic, but before final transmission of the alert, e.g. to activate on-site or off-site sound devices, and/or alert security personnel, guard service or law-enforcement, the system may require a user's confirmation, e.g. manually or by voice command.

In embodiments of the invention, one or more virtual perimeter zone can be defined and entered into the security system by the user, or alternatively the security system may be programmed to automatically detect or learn typical virtual perimeter zones through its image processing module based on visual features of a target area to be protected that are captured by the imaging device (e.g. fenced in area, doors, driveway or similar visual clues). The virtual perimeter zones serve as one or more parameter for the image processing module, in particular, in a rule or algorithm of the breach detection component to detect a virtual perimeter zone breach, and/or in the computing device's determination to trigger the one or more alert device. The virtual perimeter zones typically include an outer virtual perimeter and several especially sensitive virtual perimeter zones, for example, entrance area, back door, window areas, mailbox area, swimming pool, etc. If the area under surveillance is discontinuous, instead or in addition to an outer virtual perimeter, a number of virtual perimeter zones and optionally virtual perimeter subzones or overlapping zones can be defined and entered. The system of the invention, and in particular, the image processing module, more specifically its breach detection component, is configured to detect a breach of the one or more virtual perimeter zone if an object is found to cross a perimeter zone boundary, or to suddenly appear within a perimeter zone. Typically, a virtual perimeter zone entered to protect a target area to be secured extends well beyond the actual target area to be protected, to provide an advance warning of an imminent breach. For example, the additional distance that the virtual perimeter zone extends outward from one or more outer boundary of a physical perimeter zone that it corresponds to and aims to protect could be the equivalent of 2, 5, 10, 50, 100, 1000 feet, or more, depending on type of target to be protected and speed of potential objects to breach.

According to an exemplary embodiment of the present invention, data may be provided to the system, stored by the system and/or provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present invention, some of the applications of the present invention may not be accessible when not connected to a network, however a user or a module/component of the system itself may be able to compose data offline from the remainder of the system that will be consumed by the system or its other components when the user/offline system component or module is later connected to the system network.

Referring to FIG. 4, a schematic overview of a system in accordance with an embodiment of the present invention is shown. The system is comprised of one or more application servers 403 for electronically storing information used by the system. Applications in the server 403 may retrieve and manipulate information in storage devices and exchange information through a WAN 401 (e.g., the Internet). Applications in server 403 may also be used to manipulate information stored remotely and process and analyze data stored remotely across a WAN 401 (e.g., the Internet).

According to an exemplary embodiment, as shown in FIG. 4, exchange of information through the WAN 401 or other network may occur through one or more high speed connections. In some cases, high speed connections may be over-the-air (OTA), passed through networked systems, directly connected to one or more WANs 401 or directed through one or more routers 402. Router(s) 402 are completely optional and other embodiments in accordance with the present invention may or may not utilize one or more routers 402. One of ordinary skill in the art would appreciate that there are numerous ways server 403 may connect to WAN 401 for the exchange of information, and embodiments of the present invention are contemplated for use with any method for connecting to networks for the purpose of exchanging information. Further, while this application refers to high speed connections, embodiments of the present invention may be utilized with connections of any speed, provided the overall speed requirements of a user with regard to alerts received in regard of a breach of a virtual perimeter are met.

Components or modules of the system may connect to server 403 via WAN 401 or other network in numerous ways. For instance, a component or module may connect to the system i) through a computing device 412 directly connected to the WAN 401, ii) through a computing device 405, 406 connected to the WAN 401 through a routing device 404, iii) through a computing device 408, 409, 410 connected to a wireless access point 407 or iv) through a computing device 411 via a wireless connection (e.g., CDMA, GMS, 3G, 4G) to the WAN 401. One of ordinary skill in the art will appreciate that there are numerous ways that a component or module may connect to server 403 via WAN 401 or other network, and embodiments of the present invention are contemplated for use with any method for connecting to server 403 via WAN 401 or other network. Furthermore, server 403 could be comprised of a personal computing device, such as a smartphone, acting as a host for other computing devices to connect to.

According to an embodiment of the present invention, the communications means of the system may be, for instance, any means for communicating data, voice or video communications over one or more networks or to one or more peripheral devices attached to the system, or to a system module or component, including e.g. both on-site to off-site communication, and off-site to on-site communication. Appropriate communications means may include, but are not limited to, wireless connections, wired connections, cellular connections, data port connections, Bluetooth® connections, or any combination thereof. One of ordinary skill in the art will appreciate that there are numerous communications means that may be utilized with embodiments of the present invention, and embodiments of the present invention are contemplated for use with any communications means.

Traditionally, a computer program consists of a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, a distributed filesystem (such as HDFS), relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation Python, C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computing devices that are communicatively coupled to dissimilar computing and storage devices over a network, such as the Internet.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will be apparent to those of ordinary skill in the art from this description. There may be aspects of this invention that may be practiced without the implementation of some features as they are described. Other additional features and variations have not been described in detail but will be immediately apparent to one of ordinary skill in the art. A myriad of such modifications in the various aspects of the invention that do not depart from the spirit and scope of the present invention are possible. Accordingly, the detailed drawings, descriptions and examples are intended for illustrative purposes only, and should not be construed restrictively.

1. A system for security monitoring including one or more imaging devices operably linked to a computing device, the system comprising:
the imaging device being configured to provide image data to an image processing module of the computing device;
the computing device being configured to receive the image data and to process the image data in its image processing module; wherein
said image processing module includes a deep neural network (DNN), an object detection component, a breach detection component, and an object classification component, and is configured for entry of one or more virtual perimeter zones;
said object detection component is configured to detect one or more objects in the image data;
said breach detection component is configured to detect one or more objects causing a breach within the virtual perimeter zone;
said object classification component is configured to determine one or more classes for the detected object causing the breach;
wherein the computing device is operably linked to one or more alert devices, and is configured to trigger the alert device if the detected object causing the event is of one or more security-relevant classes; and
wherein said object classification component is configured to use the DNN to classify the one or more detected objects as human, vehicular, and inanimate.

2. The system of claim 1, said image processing module additionally comprising an object tracking component and a behavior detection component,
wherein the object tracking component is configured to track one or more virtual perimeters breaching mobile object,
wherein said behavior detection component is configured to detect one or more behaviors of the tracked object to allow the image processing module to identify risk-relevant behavior in one of its components, said risk-relevant behavior including stopping or prolonged presence of a mobile object, vehicle or person in one or more virtual perimeter zones.

3. The system of claim 1, wherein the computing device is configured to reduce the amount of image data processed in one or more components of its image processing module to image data extracted from one or more reduced data sources including one or more virtual perimeter zones, a delta determined from a series of image frames, and one or more selected representative image frames from a series of image frames.

4. The system of claim 3, wherein the computing device is configured to extract data from one or more virtual image zones, and said extracted data is selected for further image data processing by one or more of the components of the image processing module.

5. The system of claim 3, wherein the computing device is configured to extract a delta between two or more individual frames of a series of image frames, and said extracted delta is selected for further image data processing by one or more of the components of the image processing module.

6. The system of claim 3, wherein the computing device is configured to select one or more most representative image frames of one of the objects detected in a series of multiple image frames of larger quantity than the one or more most representative frames, and communicates only the one or more most representative image frames to one of the components of the image processing module, including one or more of the object detection components, object tracking components, breach detection components, behavior detection components, event detection components, and object classification components.

7. The system of claim 1, wherein the one or more virtual perimeter zones extends beyond one or more outer boundaries of a corresponding to be protected physical perimeter zone by a distance of 2 feet or more.

8. The system of claim 1, wherein the computing device is configured to compress the image data before receiving it in the image processing module, and to compress data related to image data processing including DNN coefficients and DNN model update data in the image processing module.

9. The system of claim 8, wherein the computing device is configured to compress data including image data and data related to image processing before receiving it by transmission to the image processing module, and to uncompress said data after transmission.

10. The system of claim 8, wherein the computing device is configured to compress image data and DNN coefficients data before transmission to the image processing module, and to process it in one or more image processing module components in compressed form.

11. The system of claim 8, wherein the image processing module is configured to receive data that includes DNN coefficient data but not image data, to create an updated DNN model in one of its components, and to transmit it in compressed form to one or more image processing module components.

12. The system of claim 1, wherein the alert is transmitted to a user and the user is required to confirm before final transmission, the final transmission including one or more of sounding of a sound-emitting device or siren and transmission to one or more of security personnel, guard service, and law-enforcement.

13. A method for security monitoring, the method comprising:
providing image data from one or more imaging devices to one or more computing devices, wherein said computing device includes an image processing module which is configured with one or more virtual perimeter zones;
receiving said image data in an image processing module of the computing device; and
further processing the image data in an object detection component, a breach detection component, and an object classification component of the image processing module;
wherein said further processing includes:
detecting one or more objects in said object detection component,
detecting a virtual perimeter breaching object in the breach detection component, and
determining one or more classes for each object in said object classification component; and
determining if the virtual perimeter breaching object is of one or more security-relevant classes thus detecting a security-relevant breach;
upon detecting a security-relevant breach, triggering an alert device operably connected to the one or more computing devices; and
extracting image data by selecting one or more reduced data sources that includes a single most representative image frame selected from a plurality of image frames of the image data.

14. The method for security monitoring of claim 13, additionally comprising:
further processing the image data in an object tracking component and a behavior detection component of the image processing module, wherein said further processing includes:
tracking one or more virtual perimeter breaching objects in said object tracking component,
detecting a behavior of the tracked object in the behavior detection component,
determining if the behavior is of one or more risk classes thus identifying a risk-relevant behavior; and
upon identifying one or more risk-relevant behaviors, triggering an alert device operably connected to the one or more computing devices.

15. (canceled)

16. The method of claim 13, wherein one or more of computing devices, image processing modules, object detection components, breach detection components, and object characterization components receive only the extracted image data.

17. The method of claim 16, wherein the computing device includes multiple devices or units thereof configured in a network, and all off-site units of said network receive only the extracted image data.

18. The method of claim 13, wherein said reduced data source includes a virtual perimeter zone.

19. The method of claim 13, wherein said reduced data source includes a delta determined from the plurality of image frames.

20. The method of claim 13, wherein the single most representative image frame selected from the plurality of image frames of the image data is the single most representative image of a single imaging device.

21-26. (canceled)

27. The system of claim 1, wherein said object classification component is configured to use the DNN to classify the one or more detected objects as botanical.

28. The system of claim 1, wherein classifying the one or more detected objects as vehicular includes classifying the one or more detected objects as an object selected from the group consisting of a car, a truck, and a motorcycle.

29. The system of claim 1, wherein classifying the one or more detected objects as inanimate includes classifying the one or more detected objects as an object selected from the group consisting of a road, a wall, a fence, and a building.

30. The system of claim 27, wherein classifying the one or more detected objects as botanical includes classifying the one or more detected objects as an object selected from the group consisting of trees, plants, grass, and flowers.

31. A system for security monitoring, the system including one or more imaging devices operably linked to a computing device, the system comprising:
the imaging device being configured to provide image data to an image processing module of the computing device;
the computing device being configured to receive the image data and to process the image data in its image processing module; wherein
said image processing module includes a deep neural network (DNN), an object detection component, an event detection component, and an object classification component, and is configured for entry of one or more virtual perimeter zones;
said object detection component is configured to detect one or more objects in the image data;
said event detection component is configured to detect one or more objects causing an event within the virtual perimeter zone;
said object classification component is configured to determine one or more classes for the detected object causing the event;
wherein the computing device is operably linked to one or more alert devices, and is configured to trigger the alert device if the detected object causing the event is of one or more security-relevant classes; and
wherein said object classification component is configured to use the DNN to classify the one or more detected objects as known or learned threatening objects and known or learned harmless objects.

32. The system of claim 31, wherein classifying the one or more detected objects as known or learned threatening objects and known or learned harmless objects includes the object classification component learning the known or learned threatening objects and the known or learned harmless objects based on data provided by the image processing module.

33. The system of claim 31, wherein the known or learned threatening objects include individuals, vehicles, and animals, and the known or learned harmless objects include individuals, vehicles, and animals.
